(19) United States
(12) Patent Application Publication
(10) Pub. No.: US 2008/0158925 A1
(43) Pub. Date: Jul. 3, 2008

(54) Power supply circuit having two filter members and liquid crystal display using same

(75) Inventors: Jia-Hui Tu, Shenzhen (CN); Tong Zhou, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/005,731

(22) Filed: Dec. 27, 2007

(30) Foreign Application Priority Data
Dec. 29, 2006 (TW) 95149719

(51) Int. Cl. H02M 7/06; H02M 7/00; G09G 5/00

(52) U.S. Cl. 363/126; 363/125; 345/211

(57) ABSTRACT

An exemplary power supply circuit (200) includes a rectifying circuit (240), a filter circuit (280), and a voltage stabling circuit (250). The rectifying circuit is configured to convert an alternating current voltage signal to a direct current voltage signal. The filter circuit is configured to filter the direct current voltage signal, and includes a first filter member (201) and a second filter member (202). The voltage stabling circuit is configured to stabilize the direct current voltage signal being filtered by the filter circuit. The filter circuit filters the direct current voltage signal via alternately charging and discharging the first and second filter members. The first and second filter members are electrically coupled in series during the charging process, and electrically coupled in parallel during the discharging process. A liquid crystal display (400) using the power supply circuit is also provided.

### FIELD OF THE INVENTION

The present invention relates to power supply circuits, and more particularly to a power supply circuit having two filter members for filtering direct current (DC) voltage signal. The power supply circuit may be used in a liquid crystal display.

### GENERAL BACKGROUND

Power supply circuits are widely used in modern electronic products, such as LCDs. The power supply circuit is used to provide power supply voltage signal to enable the electronic products to work.

FIG. 4 is a diagram of a conventional power supply circuit. The power supply circuit 100 is typically employed in an LCD. The power supply circuit 100 includes a transformer 130, a full-wave rectifier 140, a first capacitor 180, a voltage regulator 150, and a second capacitor 190.

The transformer 130 includes a primary coil 131 and a secondary coil 132. Two ends of the primary coil 131 respectively serve as a first input terminal 101 and a second input terminal 102 of the power supply circuit 100. The first input terminal 101 and the second input terminal 102 are used to receive an AC voltage signal from a commercial power outlet (not shown). The second coil 132 is used to adjust amplitude of the AC voltage signal, and both ends of the secondary coil 132 are electrically coupled to the full-wave rectifier 140.

The full-wave rectifier 140 is a typical bridge type rectifier, and is configured to convert the AC voltage transmitted therethrough to a direct current (DC) voltage signal. The full-wave rectifier 140 is further electrically coupled to the voltage regulator 150.

The voltage regulator 150 is a direct current to direct current (DC-DC) regulator, which is configured to carry out a function of DC voltage regulation. The voltage regulator 150 includes an input terminal 151, an output terminal 152, and a common terminal 153. The input terminal 151 and the common terminal 153 are configured to receive the DC voltage signal from the full-wave rectifier 140. The output terminal 152 and the common terminal 153 of the voltage regulator 150 respectively serve as a first output terminal 103 and a second output terminal 104 of the power supply circuit 100, and the common terminal 153 is grounded.

The first capacitor 180 is electrically coupled between the input terminal 151 and the common terminal 153 of the voltage regulator 150, and is configured to filter the DC voltage signal inputted to the voltage regulator 150. The second capacitor 190 is electrically coupled between the output terminal 152 and the common terminal 153 of the voltage regulator 150, and is configured to filter the DC voltage signal outputted the voltage regulator 150.

In operation, the power supply circuit 100 receives an AC voltage signal from the commercial power outlet (not shown) via the first and second input terminals 101, 102. The AC voltage signal is adjusted to have desired amplitude by the transformer 130, and rectified by the full-wave rectifier 140, and then converted to a DC voltage signal. The power supply circuit 100 filters the DC voltage signal via charging and discharging the first capacitor 180, and then regulates the voltage value of the DC voltage signal via the voltage regulator 150, thereby the DC voltage signal have a desired voltage value. The regulated DC voltage signal is then filtered by the second capacitor 190, and serves as a power supply voltage signal. This power supply voltage signal is finally outputted via the first output terminal 103 and the second output terminals 104 of the power supply circuit 100.

In the power supply circuit 100, the DC voltage signal is filtered by the first capacitor 180 before being regulated by the voltage regulator 150. Because the first capacitor 180 filters the DC voltage signal via charging and discharging, during the filtering process the voltage signal between two ends of the capacitor 180 is varied, thus ripple voltage signals are inevitably generated. The ripple voltage signals are added into the DC voltage signal, and the filtering effect of the power supply circuit 100 is low.

Moreover, in the power supply circuit 100, the regulated DC voltage signal outputted by the voltage regulator 150 is filtered by the second capacitor 190, and more ripple voltage signals are generated and added into the power supply voltage signal. This further lowers the filtering effect of the power supply circuit 100. Therefore, due to the ripple voltage signals, the stability and reliability of power supply voltage signal provided by power supply circuit 100 is low. When the power supply circuit 100 is employed in an LCD, such an unstable power supply voltage signal may cause the LCD to display erroneous images.

It is, therefore, desired to provide a power supply circuit and an LCD which overcomes the above-described deficiencies.

### SUMMARY

In a first aspect, a power supply circuit includes a rectifying circuit, a filter circuit, and a voltage stabling circuit. The rectifying circuit is configured to convert an alternating current voltage signal to a direct current voltage signal. The filter circuit is configured to filter the direct current voltage signal, and includes a first filter member and a second filter member. The voltage stabling circuit is configured to stabilize the direct current voltage signal after being filtered by the filter circuit. The filter circuit filters the direct current voltage signal via alternately charging and discharging the first and second filter members. The first and second filter members are electrically coupled in series during the charging process, and electrically coupled in parallel during the discharging process.

In a second aspect, a liquid crystal display includes a liquid crystal panel and a power supply circuit. The power supply circuit is configured to provide a power supply voltage signal for the liquid crystal panel, and includes a filter circuit and a voltage stabling circuit. The filter circuit includes a first filter member and a second filter member. The filter circuit filters a direct current voltage signal via the first and second filter members, and the voltage stabling circuit converts the filtered direct current voltage signal to a stable power supply voltage signal and outputs to the liquid crystal panel. The first filter member and the second filter member are electrically coupled in series during a first filtering process of the filter circuit, and are electrically coupled in parallel during a second filtering process of the filter circuit. The first filtering process and the second filtering process are alternate when the filter circuit is in operation.

Other novel features and advantages will become more apparent from the following detailed description when taken in conjunction with the accompanying drawings. In the drawings, all the views are schematic.

### BRIEF DESCRIPTION OF THE DRAWINGS

FIG. 1 is a diagram of a power supply circuit according to an exemplary embodiment of the present invention.

FIG. 2 is a waveform diagram of the power supply circuit of FIG. 1, showing a relationship between voltage signals and time when the power supply circuit is in operation.

FIG. 3 is a block diagram of a liquid crystal display according to the present invention.

FIG. 4 is a diagram of a conventional power supply circuit.

### DETAILED DESCRIPTION OF PREFERRED EMBODIMENTS

Reference will now be made to the drawings to describe a preferred and exemplary embodiment of the present invention in detail.

FIG. 1 is a diagram of a power supply circuit according to an exemplary embodiment of the present invention. The power supply circuit 200 includes a transformer 230, a rectifying circuit 240, a filter circuit 280, and a voltage stabling circuit 250. Each of the transformer 230, the rectifying circuit 240, the filter circuit 280, and the voltage stabling circuit 250 has a so-called two-ports configuration, that is, each of them has two input terminals for receives voltage signals, and also has two output terminals for outputting voltage signals.

The transformer 230 is used to adjust amplitude of an alternating current (AC) voltage signal transmitted therethrough. The transformer 230 includes a primary coil 231 and a secondary coil 232. Two ends of the primary coil 231 respectively serve as a first input terminal 211 and a second input terminal 212 of the power supply circuit 200. The first and second input terminals 211, 212 are used to receive an AC voltage signal from a power provider (not shown) such as a commercial power outlet. Each end of the secondary coil 232 is electrically coupled to the rectifying circuit 240.

The rectifying circuit 240 includes a full-wave rectifier, and the full-wave rectifier can be a bridge type rectifier. The rectifying circuit 240 is configured to convert the AC voltage signal outputted by the transformer 230 to be a direct current (DC) voltage signal.

The filter circuit 280 is configured to filter the DC voltage signal outputted by the rectifying circuit 240. The filter circuit 280 includes a first input terminal 281, a second input terminal 282, a first output terminal 283, a second output terminal 284, a first capacitor 201, a second capacitor 202, a first diode 203, a second diode 204, a transistor 205, a Zener diode 206, a first resistor 207, a second resistor 208, and a third diode 209. The first capacitor 201 and the second capacitor 202 are both configured for filter members of the filter circuit 280.

The first input terminal 281 and the second input terminal 282 are used to receive the DC voltage signal, and the second input terminal 282 is grounded. The first input terminal 281 is electrically coupled to a negative terminal of the third diode 209 via the second resistor 208, and a positive terminal of the third diode 209 is electrically coupled to the second input terminal 282.

A positive terminal of the first diode 203 is electrically coupled to the first input terminal 281. A negative terminal of the first diode 203 is electrically coupled to a positive terminal of the second diode 204 via the first capacitor 201. A negative terminal of the second diode 204 is grounded via the second capacitor 202, and the positive terminal of the second diode 204 is electrically coupled to the negative terminal of the third diode 209. One end of the second capacitor 202 is electrically coupled to the first output terminal 283, and the other end of the second capacitor 202 is electrically coupled to the second output terminal 284.

The transistor 205 is a positive channel metal oxide semiconductor field effect transistor (PMOS FET). A gate electrode of the transistor 205 is electrically coupled to the first input terminal 281 via the first resistor 207, and is also electrically coupled to a positive terminal of the Zener diode 206. A source electrode of the transistor 205 is electrically coupled to the negative terminal of the first diode 203, and is also electrically coupled to a negative terminal of the Zener diode 206. A drain electrode of the transistor 205 is electrically coupled to the negative terminal of the second diode 204.

The voltage stabling circuit 250 is configured to regulate and stabilize a value of the DC voltage signal. The voltage stabling circuit 250 includes a voltage stabilizer 254. The voltage stabilizer 254 can for example be a three-terminals integrated voltage stabilizer such as a W7800 model or a W117 model. The voltage stabilizer 254 includes an input terminal 251, an output terminal 252, and a common terminal 253. The input terminal 251 and the common terminal 253 are respectively electrically coupled to the first output terminal 283 and the second output terminal 284 of the filter circuit 280 for receiving the DC voltage signal from the filter circuit 280. The output terminal 252 and the common terminal 253 are configured to output a stable voltage signal that serves as a power supply voltage signal of the power supply circuit 200, and are respectively electrically coupled to a first output terminal 221 and a second output terminal 222 of the power supply circuit 200. Moreover, each of the input terminal 251 and the output terminal 252 is grounded via a respective capacitor 290.

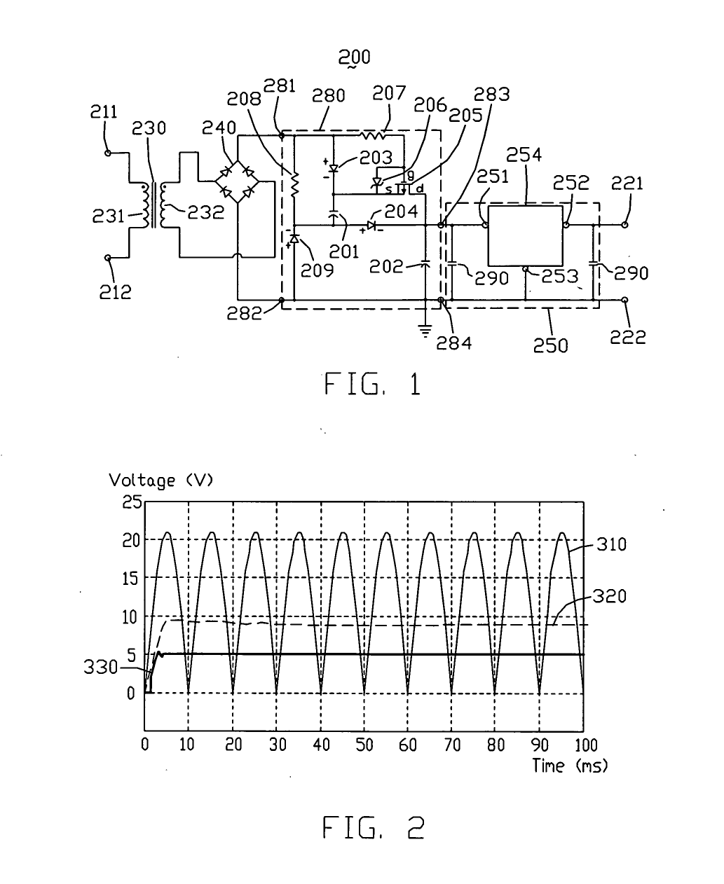

Referring also to FIG. 2, a waveform diagram of the power supply circuit 200 is shown. The waveform diagram includes a first curve 310, a second curve 320, and a third curve 330. The first curve 310 indicates the DC voltage signal inputted to the filter circuit 280, that is, the voltage signal between the first input terminal 281 and the second input terminal 282 of the filter circuit 280. The second curve 320 indicates the DC voltage signal outputted by the filter circuit 280, that is, the voltage signal between the first output terminal 283 and the second output terminal 284 of the filter circuit 280. The third curve 330 indicated the power supply voltage signal outputted by the power supply circuit 200, that is, the DC voltage signal between the first output terminal 221 and the second output terminal 222 of the power supply circuit 200.

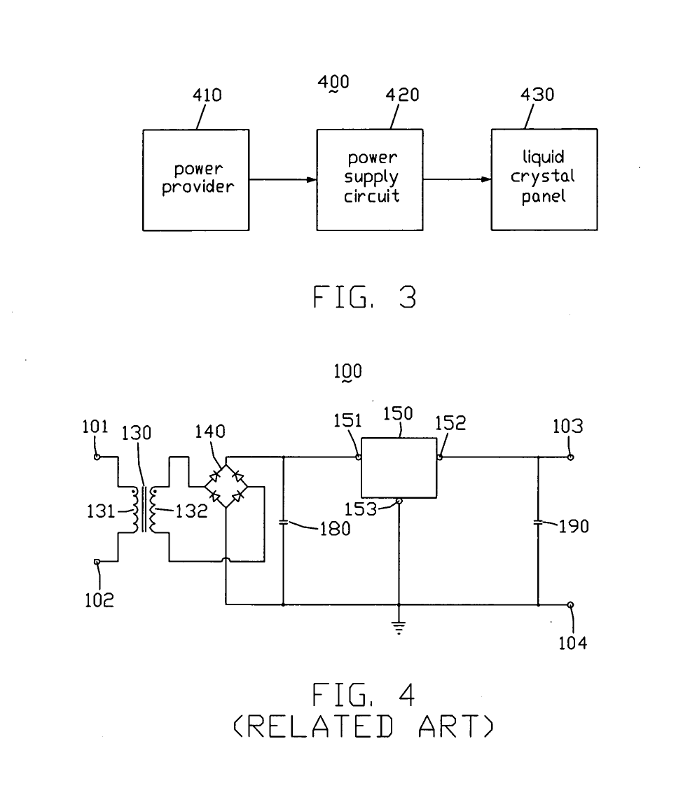

In operation, the power supply circuit 200 receives an AC voltage signal from the commercial power outlet (not shown) via the first and second input terminals 211, 212. The AC voltage signal is adjusted to have desired amplitude by the transformer 230, and then is rectified by the rectifying circuit 240 and converted to a first DC voltage signal. The first DC voltage signal is a periodical signal, and each period of the first DC voltage signal can be divided into a former part and a later part. As shown in the first curve 310 of FIG. 3, the value of the first DC voltage signal rises from 0V (volt) to a peak value (for example, 21V) according to a sine rule in the former part of each period, and decreases from the peak value to 0V in the later part of each period, also according to the sine rule.

The filter circuit 280 receives the first DC voltage signal via the first input terminal 281 and the second input terminal 282, and filters the first DC voltage signal via charging and discharging the first capacitor 201 and the second capacitor 202, so as to provide a second DC voltage signal. Details of the filtering process in the filter circuit 280 are described as follow.

In the former part of a first period, the value of the first DC voltage signal rises from 0V, and the positive DC voltage signal switches the first diode 203 and the second diode 204 on, and switches the third diode 209 and the transistor 205 off. In this situation, the first capacitor 203 and the second capacitor 204 are electrically couple in series. The positive DC voltage signal charges the first capacitor 201 and the second capacitor 202 via the first diode 203 and the second diode 204, such charging process lasts until the value of the first DC voltage signal reach the peak value thereof. Because the first capacitor 203 and the second capacitor 204 is electrically couple in series, at the end of the charging process the voltage signal stored in each of the first capacitor 203 and the second capacitor 204 approaches to half of the peak value of the first DC voltage signal. Moreover, during the charging process, the second capacitor 202 outputs the voltage signal between two ends thereof via the first output terminal 283 and the second output terminal 284 simultaneously, so as to provide a second DC voltage signal to the voltage stabling circuit 250.

Then the later part of the period comes, and the value of the first DC voltage signal starts to decrease. This causes the first diode 203 to be reverse bias and switched off, and causes the transistor 205 to be switched on. The transistor 205 then pulls the voltage value at the negative terminal of the first diode 203 down to be the same as that at the negative terminal of the second diode 204. The voltage value of the positive terminal of the second diode 204 is also pulled down because of the first capacitor 201. Thus the second diode 204 is switched off, and the third diode 209 is switched on. In this situation, the first capacitor 201 and the second capacitor 202 are electrically coupled in parallel. The filter circuit 200 stops the charging process thereof and turns to a discharging process. In the discharging process, the first capacitor 201 and the second capacitor 202 are discharged cooperatively, such that the filter circuit 280 continue to output the second DC voltage signal via the first output terminal 283 and the second output terminal 284. Moreover, when the transistor 205 is switched on, the voltage between the gate electrode and the source electrode of the transistor 205 is clamped by the Zener diode 206, thus the transistor 205 is prevented from turning to an abnormal working state.

Once the first DC voltage signal decrease to 0V, the first period is complete and a former part of the next period (i.e. the second period) comes sequentially. In the former part of the second period, the first DC voltage signal rises again, and switches on the first diode 203 and the second diode 204, as well as switches off the transistor 205 and the third diode 209 again. Thereby a new charging process starts, and the first capacitor 201 and the second capacitor 202 are electrically coupled in series. Once the first DC voltage signal reaches the peak value thereof, a later part of second period comes. The first DC voltage signal decreases again, and switches on the transistor 205 and the third diode 209, as well as switches off the first diode 203 and the second diode 204. Thereby a new discharging process starts, and the first capacitor 201 and the second capacitor 202 are electrically coupled in parallel. That is, the filter circuit 280 repeats functioning as in the previous period, and provides a second DC voltage signal to the voltage stabling circuit 250 via the first output terminal 283 and the second output terminal 284.

The second DC voltage signal is then regulated and stabilized by the voltage stabling circuit 254, such that regulated DC voltage signal is generated. The regulated DC voltage signal serves as a power supply voltage signal, and is outputted via the first output terminal 221 and second output terminal 222, so as to an electronic product such as an LCD to work.

In the power supply circuit 200, the filter circuit 280 filters the first DC voltage signal via alternately charging and discharging the first capacitor 201 and the second capacitor 202 thereof. The first capacitor 201 and the second capacitor 202 are electrically coupled in series during the charging process, and are electrically coupled in parallel during the discharging process. Moreover, the second DC voltage signal corresponds to the voltage signal between two ends of the second capacitor 202. During the filtering process, original ripple voltage signals may be generated in the filter circuit 280, however, because the second DC voltage signal is outputted by the second capacitor 202, the actual ripple voltage signals added into the second DC voltage signal can be reduced to half of the original ripple voltage signals. Thus, compared with filtering via charging a single capacitor (as described in the power supply circuit 100), the filtering effective of the filter circuit 280 is improved. Thereby, after being regulated and stabilized by the voltage stabling circuit 250, the power supply voltage signal provided by the power supply circuit 200 is more stable and reliable. Accordingly the stability and reliability of the power supply circuit 200 is improved.

Moreover, in the power supply circuit 200, the transistor 206 can also be a positive-negative-positive type bipolar junction transistor (PNP-BJT). Due to the stable second DC voltage signal, a voltage stabling tube can be used for substituting the voltage stabilizer 254.

FIG. 3 is a block diagram of a liquid crystal display according to the present invention. The liquid crystal display 400 includes a power provider 410, a power supply circuit 420, and a liquid crystal panel 430. The power provider 410 is configured to provide an AC voltage signal for the liquid crystal display 400, and can be a commercial power outlet. The power supply circuit 420 is electrically coupled to the power provider 410, and is configured to convert the AC voltage signal to a stable DC voltage signal having a desired value. The liquid crystal panel 430 is electrically coupled to the power supply circuit 420 for receiving the DC voltage signal. Moreover, the power supply circuit 420 can be the above-described power supply circuit 200, and the DC voltage signal outputted by power supply circuit 420 has a high stability. Thus the possibility for the liquid crystal display 400 to display erroneous images can be reduced, and the reliability of the liquid crystal display 400 is improved.

It is to be further understood that even though numerous characteristics and advantages of preferred and exemplary embodiments have been set out in the foregoing description, together with details of the structures and functions of the embodiments, the disclosure is illustrative only; and that changes may be made in detail within the principles of the present invention to the full extent indicated by the broad general meaning of the terms in which the appended claims are expressed.

What is claimed is:

1. A power supply circuit, comprising:
a rectifying circuit configured to convert an alternating current voltage signal to a direct current voltage signal;
a filter circuit configured to filter the direct current voltage signal, the filter circuit comprising a first filter member and a second filter member;
a voltage stabling circuit configured to stabilize the direct current voltage signal that is filtered by the filter circuit;
wherein the filter circuit filters the direct current voltage signal via alternately charging and discharging the first and second filter members; the first and second filter members are electrically coupled in series while being charged, and electrically coupled in parallel while being discharged.

2. The power supply circuit as claimed in claim 1, wherein the first filter member and the second filter member are a first capacitor and a second capacitor, respectively.

3. The power supply circuit as claimed in claim 2, wherein the filter circuit further comprises a first input terminal, a second input terminal, a first output terminal, and a second output terminal, the first and second input terminals are configured to receive the direct current voltage signal outputted by the rectifying circuit, the first and second output terminals are configured to output the direct current voltage signal being filtered to the voltage stabling circuit, and the second input terminal and the second output terminal are both grounded.

4. The power supply circuit as claimed in claim 3, wherein the filter circuit further comprises a first diode and a second diode, a positive terminal of the first diode is electrically coupled to the first input terminal, a negative terminal of the first diode is electrically coupled to a positive terminal of the second diode via the first capacitor, and a negative terminal of the second diode is grounded via the second capacitor.

5. The power supply circuit as claimed in claim 4, wherein the filter circuit further comprises a transistor and a first resistor, the transistor is a positive channel metal oxide semiconductor field effect transistor, a gate electrode of the transistor is electrically coupled to the positive terminal of the first diode via the first resistor, a source electrode of the transistor is electrically coupled to the negative terminal of the first diode, and a drain electrode of the transistor is electrically coupled to the negative terminal of the second diode.

6. The power supply circuit as claimed in claim 5, wherein the filter circuit further comprises a Zener diode, a positive terminal of the Zener diode is electrically coupled to the gate electrode of the transistor, a negative terminal of the Zener diode is electrically coupled to the source electrode of the transistor.

7. The power supply circuit as claimed in claim 5, wherein the filter circuit further comprises a second resistor and a third diode, a positive terminal of the third diode is grounded, a negative terminal of the third diode is electrically coupled to the first input terminal of the filter circuit via the second resistor, and is electrically coupled to the positive terminal of the second diode.

8. The power supply circuit as claimed in claim 1, wherein the rectifying circuit comprises a full-wave rectifier.

9. The power supply circuit as claimed in claim 8, wherein the full-wave rectifier is a bridge type rectifier.

10. The power supply circuit as claimed in claim 3, wherein the voltage stabling circuit comprises a voltage stabilizer, the voltage stabilizer comprises an input terminal, an output terminal, and a common terminal, the input terminal and the common terminal of the voltage stabilizer are respectively electrically coupled to first and second output terminal of the filter circuit, the output terminal and the common terminal are configured for a first output terminal and a second output terminal of the power supply circuit.

11. The power supply circuit as claimed in claim 10, wherein the voltage stabling circuit further comprises a third capacitor and a fourth capacitor, the third capacitor is electrically coupled between the input terminal and the common terminal of the voltage stabilizer, and the fourth capacitor is electrically coupled between the output terminal and the common terminal of the voltage stabilizer.

12. The power supply circuit as claimed in claim 1, further comprising a transformer, the transformer is configured to adjust amplitude of the alternating current voltage signal.

13. The power supply circuit as claimed in claim 12, wherein the transformer comprises a primary coil and a secondary coil, two ends of the primary coil are respectively configured for a first input terminal and a second input terminal of the power supply circuit, both ends of the secondary coil are electrically coupled to the rectifying circuit.

14. A liquid crystal display, comprising:
a liquid crystal panel; and
a power supply circuit configured to provide a power supply voltage signal for the liquid crystal panel, the power supply circuit comprising a filter circuit and a voltage stabling circuit;
wherein the filter circuit comprises a first filter member and a second filter member, the filter circuit filters a direct current voltage signal via the first and second filter members, and the voltage stabling circuit converts the filtered direct current voltage signal to a stable power supply voltage signal, and outputs the power supply voltage signal to the liquid crystal panel; the first filter member and the second filter member are electrically coupled in series during a first filtering process of the filter circuit, and are electrically coupled in parallel during a second filtering process of the filter circuit, the first filtering process and the second filtering process are alternate when the filter circuit is in operation.

15. The liquid crystal display as claimed in claim 14, wherein the filter circuit further comprises a first input terminal, a second input terminal, a first diode, and a second diode, the first and second input terminals are configured for receiving the direct current voltage signal, a positive terminal of the first diode is electrically coupled to the first input terminal, a negative terminal of the first diode is electrically coupled to a positive terminal of the second diode via the first filter member, and a negative terminal of the second diode is electrically coupled to the second input terminal via the second filter member.

16. The liquid crystal display as claimed in claim 15, wherein the filter circuit further comprises a transistor and a first resistor, the transistor is a positive channel metal oxide semiconductor field effect transistor, a gate electrode of the transistor is electrically coupled to the positive terminal of the first diode via the first resistor, a source electrode of the transistor is electrically coupled to the negative terminal of the first diode, and a drain electrode of the transistor is electrically coupled to the negative terminal of the second diode.

17. The liquid crystal display as claimed in claim 16, wherein the filter circuit further comprises a Zener diode, the Zener diode is configured to prevent the transistor from turning to an abnormal working state.

18. The liquid crystal display as claimed in claim 16, wherein the filter circuit further comprises a second resistor and a third diode, a positive terminal of the third diode is grounded, a negative terminal of the third diode is electrically coupled to the first input terminal of the filter circuit via the second resistor, and is electrically coupled to the positive terminal of the second diode.

19. The liquid crystal display as claimed in claim 14, wherein the power supply circuit further comprises a rectifying circuit, the rectifying circuit comprises a bridge type rectifier, the bridge type rectifier receives an alternating current voltage signal, and converts the alternating current voltage signal to a direct current voltage signal, and then outputs the direct current voltage signal to the filter circuit.
